(19) United States
(12) Patent Application Publication
(10) Pub. No.: US 2006/0285852 A1
(43) Pub. Date: Dec. 21, 2006

(54) Integrated maximum a posteriori (MAP) and turbo product coding for optical communications systems

(76) Inventors: Wenze Xi, Baltimore, MD (US); Tulay Adali, Columbia, MD (US)

Correspondence Address: FLESHNER & KIM, LLP, P.O. BOX 221200, CHANTILLY, VA, 20153, US

(21) Appl. No.: 11/471,717

(22) Filed: Jun. 21, 2006

Related U.S. Application Data
(60) Provisional application No. 60/692,403, filed on Jun. 21, 2005.

(51) Int. Cl. H04B 10/12

(52) U.S. Cl. 398/141

(57) ABSTRACT

An integrated maximum a posteriori equalization and turbo product coding (IMAP-TPC) system for optical fiber communications systems (OFCS) is provided that uses probabilistic characterization of the electrical current in the presence of inter-symbol interference (ISI) and noise to compensate their effects and improve the bit error rate. In the IMAP-TPC system, turbo product code (TPC) decoding is integrated with a symbol-by-symbol maximum a posteriori (MAP) detector. The MAP detector calculates the log-likelihood ratio of a received symbol using the conditional electrical probability density information, and hence obtains a much more accurate reliability measure than the traditional measure used in the TPC decoder.

### REFERENCE TO RELATED APPLICATIONS

This application claims the benefit of provisional U.S. Patent Application No. 60/692,403, filed Jun. 21, 2005.

### GOVERNMENT RIGHTS

This invention was made with government support under Grant No. NSF-CCF-0123409 awarded by the National Science Foundation. The government has certain rights in this invention.

### BACKGROUND OF THE INVENTION

1. Field of the Invention

The present invention relates to optical fiber communication systems and, more particularly, to an integrated MAP and turbo product coding system and method for mitigating the effects of physical impairments in optical fiber transmission lines.

2. Background of the Related Art

As the data rates and transmission distances increase, the limitations posed by the physical impairments in optical fiber transmission lines have become obvious. Chromatic dispersion, fiber nonlinearities (particularly the Kerr nonlinearity), polarization effects (particularly polarization mode dispersion (PMD) in terrestrial systems), and amplified spontaneous emission (ASE) noise from the amplifiers, are the main sources of impairment in optical communication systems. In practice, system power is limited at the high end by fiber nonlinearity and at the low end by ASE noise. Since it is financially advantageous to place the system amplifiers as far apart as possible and since the ASE noise increases as the amplifier spacing increases, modern systems operate close to the edge of what the physical impairments allow.

Optical fiber communication systems have made tremendous progress in the last decade with unprecedented individual channel data rates as well as large numbers of channels transmitting simultaneously in one optical fiber. One recent demonstration used 159 channels with each channel operating at 42.7 Gb/s to achieve low bit error rates over a distance of 2100 km and another one with 256 channels at 42.7 Gb/s over a distance of 300 km. At the present time, cost and implementation issues prevent such system designs from being commercially deployed.

Dispersion and nonlinear optical interactions in the optical fiber, polarization effects in the optical fiber and optical devices, and noise generated by the optical amplifiers are the principal physical phenomena that lead to system degradation. These phenomena can induce a number of impairments, such as amplitude and timing jitter, and inter-symbol and inter-channel interference (ISI and ICI, respectively) in the received signal. The complexity of the problem arises from the way in which these physical phenomena interact with the system parameters. For example, PMD is an important source of ISI and ICI, limiting the transmission rates and distances in installed terrestrial fiber systems. The specific transmitter and receiver design, which includes the choice of transmission format, optical and electrical filters, and the detection scheme, can significantly alter the penalty due to PMD. Moreover, the choice of the transmission format, e.g., RZ or NRZ, dramatically affects the bit error rate due to the nonlinear optical interactions in the optical fiber during transmission.

In the drive to increase transmission rates, the channel count in a single fiber has been significantly increased. Because of the finite bandwidth of the optical amplifiers, this increase has been made at the expense of employing very narrowly spaced channels, i.e., by using a dense wave-division-multiplexed (WDM) system. The tight packing of channels increases nonlinear optical interactions between adjacent channels in the optical fiber leading to increased timing and amplitude jitter due to ICI. These effects can be reduced by using specific transmission formats, such as duobinary signaling with polarization division multiplexing, however, the actual performance improvement also depends on the receiver design. Optimizing the system design also requires optimization of the optical fiber dispersion, which is a complicated and difficult task given the number of system parameters that need to be taken into account and the additional variability added due to the changes in temperature.

The complexity of system design optimization is a key barrier in the deployment of systems with impressive data rates and reaches. Given the high cost of new system installation, there is a need to look at ways of optimizing designs based on existing installations. One may upgrade parts of a system, but in general it is extremely expensive to put in all new fiber. Further, it is likely that all-optical networks will become prevalent in the future, using optical switches to connect different fiber links without conversion to electronic signals, thus saving costs. However, they will add additional variability into the equation as the distance of routes will dynamically change as well as the fiber types and dispersion distributions. Hence, the overall performance depends on the data format, optical fiber dispersion, dispersion distribution, number of optical channels, optical channel spacing, transmission distance, and optical receiver design in a complex and interactive manner. Further, the nonstationarity of some of the impairments introduced by changes such as temperature or routing add a requirement for adaptivity into the already difficult optimization task.

The promise of electrical signal processing techniques for optical communications was noted more than a decade ago, but their successful demonstrations for high-speed optical communications have only appeared more recently. Adaptive filters implemented as simple feedforward or feedback equalizers or interference cancelers, maximum likelihood sequence (MLS) detectors, and adaptive threshold selectors have all been demonstrated to mitigate errors due to ISI and ICI introduced by various distortion mechanisms. They have been shown to be effective in combating PMD chromatic dispersion, the timing jitter due to acoustic response, and cross-phase modulation between channels in WDM systems.

However, until recently, almost all of the electronic domain solutions that were proposed for optical communications or are commercially available are based on standard techniques, such as the use of feedforward or feedback filters designed on mean square (MSE) error minimization and forward error correction (FEC) codes such as the Reed-Solomon codes. Hence, these solutions also have a number of important limitations. First, because of the speed limitations posed by the hardware, the equalizers normally operate in the analog domain, and hence they minimize the average MSE in the bit period rather than at the sampling instance, resulting in suboptimal performance. Moreover, the filter coefficients are typically user-tuned to minimize the MSE, computed adaptively by the least mean squares algorithm, or by a gradient descent procedure that uses a control signal such as the eye opening or an error monitor. Consequently, the performance is suboptimal especially when tracking is required. The main limitation for these standard electrical domain approaches stems from the fact that they are not designed for the optical channel, and, as such, do not deliver the performance gains typically required by system designers.

### SUMMARY OF THE INVENTION

An object of the invention is to solve at least the above problems and/or disadvantages and to provide at least the advantages described hereinafter.

Therefore, an object of the present invention is to provide a system and method for improving the performance of fiber optic communications systems.

Another object of the present invention is to provide a system and method for reducing the bit error rate in coded fiber optic communications systems.

Another object of the present invention is to jointly optimize decoding and maximum a posteriori detection in a coded fiber optic communication system using estimated conditional electrical probability density functions.

Another object of the present invention is to provide an integrated maximum a posteriori detector and turbo product code decoder.

To achieve at least the above objects, in whole or in part, there is provided a system for improving the performance of a fiber optic communications system, comprising a photodetector for converting a modulated and coded optical signal that has been transmitted through an optical fiber into an electrical signal, a conditional electrical probability density function (pdf) estimator for estimating a conditional pdf of the electrical signal, and an integrated maximum a posteriori equalization and turbo product coding (IMAP-TPC) system for receiving the conditional pdf of the electrical signal and for using the conditional pdf to: (1) decode the electrical signal into candidate codewords; and (2) determine which of the candidate codewords are most likely correct.

To achieve at least the above objects, in whole or in part, there is also provided system for improving the bit error rate (BER) of a modulated and coded optical signal that has been transmitted through an optical fiber, comprising a conditional electrical probability density function (pdf) estimator for receiving an electrical signal that is representative of the modulated and coded optical signal and for estimating a conditional pdf of the electrical signal and an integrated maximum a posteriori equalization and turbo product coding (IMAP-TPC) system for receiving the conditional pdf electrical signal and for using the conditional pdf to: (1) decode the electrical signal into candidate codewords; and (2) determine which of the candidate codewords are most likely correct.

To achieve at least the above objects, in whole or in part, there is also provided an optical communications system, comprising a modulator for modulating and coding an optical signal, an optical fiber transmission system for transmitting the modulated and coded optical signal, a receiver for receiving and converting the transmitted optical signal into an electrical signal, a conditional electrical probability density function (pdf) estimator for receiving electrical signal and estimating a conditional pdf of the electrical signal, and an integrated maximum a posteriori equalization and turbo product coding (IMAP-TPC) system for receiving the conditional pdf electrical signal and for using the conditional pdf to: (1) decode the electrical signal into candidate codewords; and (2) determine which of the candidate codewords are most likely correct.

To achieve at least the above objects, in whole or in part, there is also provided a method of improving the bit error rate (BER) of an optical signal that has been coded using a turbo product code coding scheme and transmitted through an optical fiber, comprising converting the coded optical signal to an electrical signal, generating a conditional electrical probability density function (pdf) of the electrical signal, and using the conditional pdf to: (1) decode the electrical signal into candidate codewords; and (2) determine which of the candidate codewords are most likely correct.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1A is a flowchart of steps in a method for improving the BER of an optical signal that has been coded using a turbo product code coding scheme and transmitted through an optical fiber, in accordance with one embodiment of the present invention

FIG. 1B is a block diagram of an integrated MAP equalization and turbo product coding (IMAP-TPC) system 100, in accordance with one preferred embodiment of the present invention;

FIG. 2 is a block diagram of one preferred embodiment of the IMAP-TPC decoder 120 of FIG. 1;

FIG. 3 is a plot comparing estimated conditional pdfs with the true pdfs of the electrical current, where only 3-bit ISI is considered;

FIG. 4 is a block diagram of BCH(n1,k1)×BCH(n2,k2) product code;

FIG. 5 is a block diagram of an mth stage of the TPC decoder of FIG. 2;

FIG. 6 is a block diagram of an optical communications system utilizing the IMAP-TPC system of the present invention;

FIGS. 7A-7C are eye diagram plots for DGD=0 ps and for the conditions: (A) noise free; (B) OSNR=12.23 dB; and (C) OSNR=8.55 dB;

FIGS. 8A-8C are eye diagram plots for DGD=57 ps and for the conditions: (A) noise free; (B) OSNR=12.23 dB; and (C) OSNR=8.55 dB;

FIGS. 9A-9C are eye diagram plots for DGD=80 ps and for the conditions: (A) noise free; (B) OSNR=12.23 dB; and (C) OSNR=8.55 dB;

FIG. 10 is a plot of BER vs OSNR for four methods (adaptive thresholding, MAP detector, TPC, and IMAP-TPC), where DGD is 57 ps; and

FIG. 11 is a plot of BER vs OSNR for four methods (adaptive thresholding, MAP detector, TPC, and IMAP-TPC), where DGD is 80 ps.

### DETAILED DESCRIPTION OF PREFERRED EMBODIMENTS

To upgrade the capacity of existing optical fiber communications systems, it is simply not practical to install newly designed and optimized systems, since the cost of installing new fiber spans and amplifier huts is prohibitive. The only cost effective approach for overcoming this major barrier to the massive deployment of optical fiber communications in WDM networks is to upgrade the transmitters and receivers. Consequently, a major thrust in the field has been to start using solutions in the electrical domain such as equalization and coding. Because of the finite bandwidth of the optical amplifiers, the only way to increase capacity is to increase spectral efficiency. For this reason, sophisticated, highly-spectrally efficient modulation formats are becoming increasingly attractive. Such formats include vestigial sideband (VSB) modulation, quadrature and differential phase shift keying (QPSK and DPSK), and duobinary signaling. Additional gains in spectral efficiency could also be won by using polarization-division multiplexing, which has the potential to double the number of transmitted bits per wavelength.

Electrical-domain equalization techniques such as linear adaptive filters have been demonstrated to be effective in mitigating the effects of inter-symbol interference (ISI) introduced by e.g., the polarization mode dispersion (PMD) or chromatic dispersion in optical communications systems. These equalizers use a feedback or feedforward structure and their coefficients are updated such that the mean square error (MSE) or another error statistic is minimized. Maximum-likelihood detection based techniques, such as maximum likelihood sequence estimation (MLSE) or maximum a posteriori (MAP) detection, are recently proposed for PMD mitigation. MLSE bases its decision on the observation of a sequence of received signals, and searches for the best path through a trellis that maximizes the joint probability of received signals. The MAP detector, on the other hand, makes decisions on a symbol-by-symbol basis and is optimum in the sense that it minimizes the probability of bit errors. Both the MAP detector and the maximum likelihood sequence (MLS) estimator are superior to equalizers that rely on error metrics such as the MSE, as they directly minimize the errors in a symbol or sequence.

Amplified spontaneous emission (ASE) noise is the dominant noise source in optical communication systems. At the end of optical fiber propagation at the receiver, the ASE noise generated by the amplifiers installed in the fiber accumulate and can significantly increase the bit-error-rate (BER). Forward error-correction (FEC) coding has demonstrated to be an effective way to improve reliability. It can be used to reduce the number of optical amplifiers used during optical fiber transmission, thereby minimizing the required optical power, and hence lowering the effects of fiber nonlinearity as well.

These two solutions, equalization and coding, are typically designed independent from each other. In the system and method of the present invention, equalization and coding are integrated and designed together. This is a much more desirable scheme because of its potential to enhance the effectiveness of soft information interchange between the equalizer and the decoder. Moreover, the integration of equalization into the decoding process does not significantly increase the computational cost. However, as will be explained in more detail below, it provides significant performance gains.

Joint coding and equalization (JCE) techniques proposed for wireless or wireline communications systems are different from the integrated equalization and decoding technique of the present invention. JCE needs matched filters to generate sufficient statistics, which are not available for optical communications systems as these channels do not have the additive white Gaussian noise property. The propagation and the receiver structure in an optical communications channel lead to nonlinear and non-Gaussian channel characteristics, and the photodetector that converts light into electrical current leads to a signal-dependent noise term in the receiver. An aspect of the present invention is the use of an analytical formula for the probability density of the filtered electrical current in the presence of PMD and ASE noise after the optical receiver, which enables the design of such an integrated system for optical fiber communications systems (OFCS).

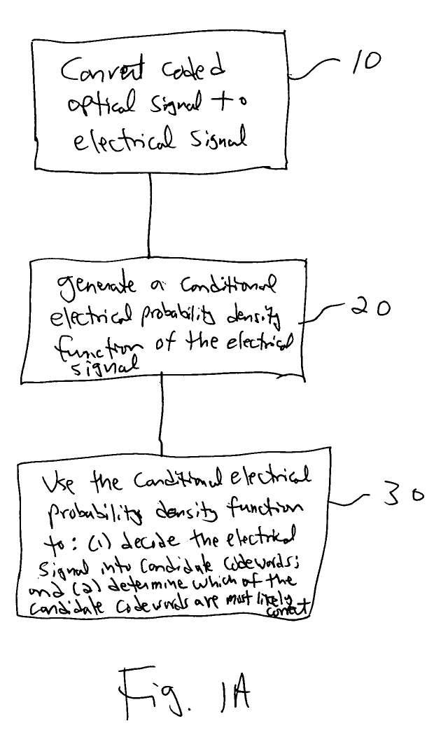

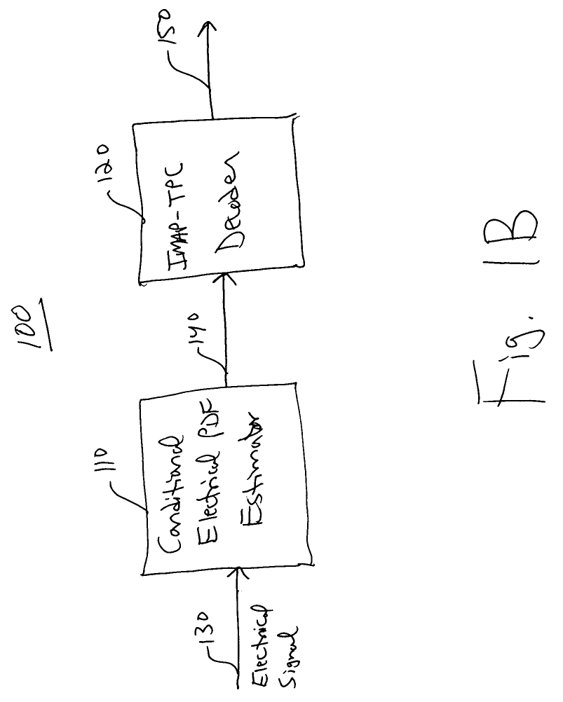

FIG. 1A is a flowchart of steps in a method for improving the BER of an optical signal that has been coded using a turbo product code coding scheme and transmitted through an optical fiber, in accordance with one embodiment of the present invention. The method starts at step 10, where the coded optical signal is converted to an electrical signal. Then, at step 20, a conditional electrical probability density function (pdf) of the electrical signal is generated. At step 30, the conditional pdf is used to: (1) decode electrical signal into candidate codewords; and (2) determine which of the candidate codewords are most likely correct. This general method will be described in more detail below in connection with discussions of the hardware used to implement the present invention, as well as the theory of operation of the present invention;

FIG. 1B is a block diagram of an integrated MAP equalization and turbo product coding (IMAP-TPC) system 100, in accordance with one preferred embodiment of the present invention. The system 100 includes a conditional electrical probability density function (pdf) estimator 110 and an IMAP-TPC decoder 120. In operation, an electrical signal 130 is sent to the conditional pdf estimator 110. The electrical signal 130 is generated by a photodetector (not shown) that detects an optical signal at a receiving end of an OFCS. The optical signal (not shown) is coded using a TPC encoder (not shown).

The electronic conditional pdf estimator estimates the conditional pdf of the electrical signal 130, and outputs the conditional pdf 140 to the IAP-TPC decoder 120. The IMAP-TPC decoder generates candidate codewords, and outputs a decision 150 as to which of the candidate codewords is most likely the correct codeword.

One preferred embodiment of the IMAP-TPC decoder 120 is shown in FIG. 2. The IMAP-TPC decoder 120 preferably includes a MAP detector 200, a TPC decoder 210 and an interleaver 220.

The IMAP-TPC system 100 is designed for OFCS that utilize TPC as a coding method. TPC is based on a product of two constituent Bose, Chaudhuri, and Hocquenghem (BCH) codes using soft input soft output (SISO) iterative decoding. The TPC decoder 210 preferably uses a sub-optimal decoding algorithm, preferably a Chase-type II algorithm, that can reach near maximum likelihood decoding performance of linear block codes. The Chase-type II algorithm is preferably implemented in a soft input soft output (SISO) iterative decoder to search for the most possible BCH codewords for soft decoding. The conditional pdfs 140 are input to the symbol-by-symbol MAP detector 200. The MAP detector 200 outputs a log-likelihood ratio (LLR), which is then integrated into soft decoding performed by the TPC decoder 210. Hence, the IMAP-TPC system 100 achieves significantly better performance than simple concatenated schemes, as well as schemes in which conditional pdfs are integrated directly into the maximum-likelihood decoding process using the Viterbi algorithm. It is also different than turbo equalization, in that the IMAP-TPC system 100 offers a computationally and structurally simpler and more efficient technique for integrated equalization and coding.

MLSE and MAP Detection for Optical Channel Equalization

A conditional electrical pdf, i.e., the distribution of the electrical current for a given transmitted sequence, provides the complete statistical information in the electrical domain for a channel with ISI and noise provided that it includes a memory to match the span of the ISI. An accurate characterization takes into account both the physical sources of ISI such as PMD and chromatic distortion, and the effects of optical and electrical filters besides the distribution of noise. The conditional electrical pdf, which describes the dependence of a received symbol on the transmitted bit sequence, has the form fy(yₙ| . . . , xₙ₋₂, xₙ₋₁, xₙ, xₙ₊₁, xₙ₊₂, . . . ), where yₙ denotes the sampled electrical current y(nt₀) in the n-th bit slot after clock recovery, and xₙ denotes the corresponding transmitted information bit. The conditional electrical pdf can thus be used for maximum-likelihood based ISI compensation, such as in MLSE or MAP detection.

One can practically estimate the conditional pdf of electrical current given a transmitted sequence in the presence of PMD-induced ISI and ASE noise and use these conditional pdfs to implement a symbol-by-symbol MAP detector and an MLS detector to compensate for the PMD-induced pulse spreading and distortion in the received signal.

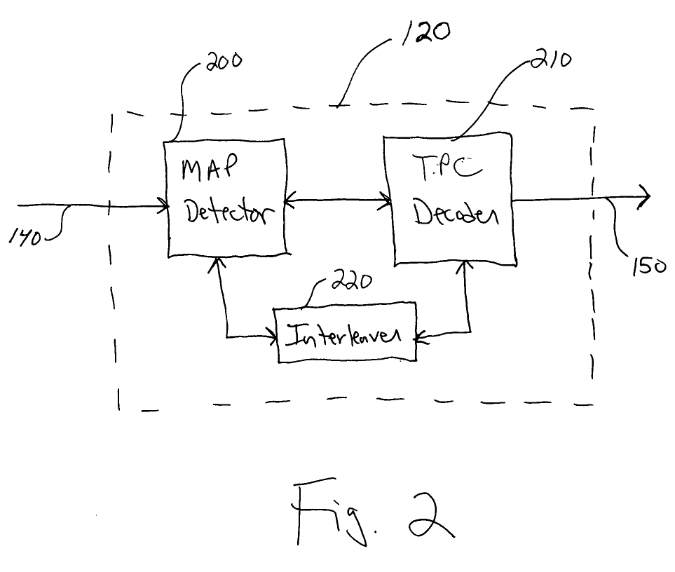

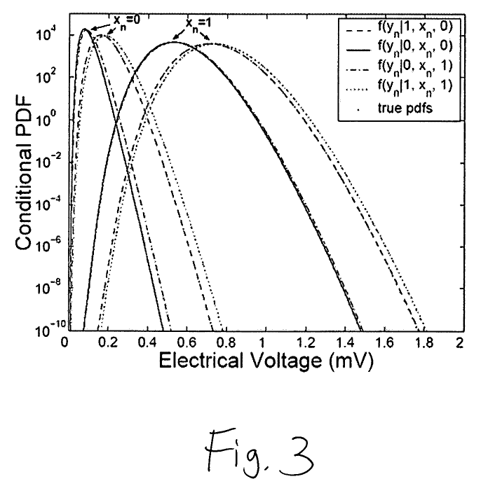

FIG. 3, which is a plot comparing the estimated conditional pdfs with the true pdfs of the electrical current, where only 3-bit ISI is considered. The true pdfs are calculated assuming that the optical phase is known before the receiver. However, the estimated pdfs are calculated using the mean electrical current value without any optical phase information. As shown in FIG. 3, the estimated conditional pdfs agree very well with the true pdfs. In other words, even without the knowledge of the optical phase, one can estimate the conditional pdfs fairly accurately. These pdfs, as will be shown below, provide valuable information required for ML-based equalization and soft decoding.

In the following development, we assume that the conditional pdfs are estimated such that the main sources of ISI and noise are taken into account. We also note that xiε{0, 1} and that the ISI-induced pulse spreading is contained within a window of length 2j−1 bits where j is an integer. To detect the ith symbol such that i>j, the decision window [m,m+2j−2] of length 2j−1 of a MAP detector is shifted over the received sequence where m>1. The decision is made by the evaluation of

$$\begin{matrix}{\hat{x}}_{i} = arg \{ {max}_{{x}_{i}} F ( y \text{\vert} {x}_{i} ) \} \\ where y = ( {y}_{i} , {y}_{i + 1} , ⋯ , {y}_{m + 2 j - 1} ) and & ( 1 ) \\ F ( y \text{\vert} {x}_{i} ) = {\sum }_{{x}_{i + 1} , ⋯ , {x}_{m + 2 j - 2}}^{} f ( {y}_{i} \text{\vert} {x}_{m} , {x}_{m + 1} ⋯ , {x}_{m + 2 j - 2} ) \times {\sum }_{{x}_{m + 2 j - 1}}^{} f ( {y}_{i + 1} \text{\vert} {x}_{m + 1} , {x}_{m + 2} ⋯ , {x}_{m + 2 j - 1} ) ⋯ \times {\sum }_{{x}_{m + 3 j - 2}}^{} f ( {y}_{m + 2 j - 1} \text{\vert} {x}_{i} , ⋯ , {x}_{m + 3 j - 2} ) . & ( 2 )\end{matrix}$$

The MLS detector in the presence of both ISI and noise is given by

$$\hat{x} = arg \{ {max}_{x} {\prod }_{i = m + j}^{N} f ( {y}_{i} \vert {x}_{m} , {x}_{m + 1} ⋯ , {x}_{m + 2 j - 2} ) \} \qquad ( 3 )$$

where x=(xᵢ, xᵢ₊₁, . . . , x_{N}), and the Viterbi algorithm is used to determine the most likely sequence.

Both the MAP detector 200 and the MLS estimator are optimum in the sense that they minimize the BER. MLS estimator bases its decision on a sequence of received signals and searches for the best path through a trellis to maximize the joint probability of the received signals. The trellis structure of the MLS estimator, however, introduces significant time delay during decision. Moreover, as the memory length of the optical channel increases, the number of trellis states increases exponentially. The MAP detector 200, on the other hand, makes decisions on a symbol-by-symbol basis. It introduces much smaller time delay during decision than an MLS estimator. The LLR of the received symbol can also be calculated by first finding \hat{x} and its complementary symbol \hat{x}_{c} using (1), and then comparing the LLR of xᵢ=\hat{x} to xᵢ=\hat{x}_{c} using equation (2). The received symbol LLR (the output of MAP detector 200), provides not only the noise information but also the ISI information, e.g., that introduced by PMD or chromatic dispersion. Hence, it can be integrated into the soft decoding process in an FEC decoder, significantly reducing the BER.

Integrated MAP Equalization and TPC Coding

As described above, the estimated conditional electrical pdfs can be used for maximum-likelihood (ML) based equalization techniques, such as MLSE and symbol-by-symbol MAP detection for dispersion compensation. They can also be used for iterative SISO TPC decoding methods. The IMAP-TPC system 100 of the present invention uses estimated conditional electrical pdfs and symbol-by-symbol MAP detector 200. The symbol-by-symbol MAP detector 200 uses the conditional electrical pdfs as its input and outputs the LLR soft information by observing a received sequence and, hence, provides an improved reliability measure as the input to the TPC decoder 210. The TPC decoder 210 is preferably a suboptimal decoder that offers a good compromise between decoding performance and complexity, so that the solution is attractive for implementation in an OFCS.

The IMAP-TPC system 100 is different from, not only the turbo equalization, but also other ML-based joint coding and equalization methods. Turbo equalization, which iteratively performs equalization and decoding, can achieve significant performance gains when ISI is present. However, it needs to exchange information between the equalizer and the decoder. Therefore, it is both computationally complex and is complicated in structure. The ML-based JCE method has an MLSE receiver structure consisting of a whitened matched filter followed by a Viterbi decoder for Gaussian channels with ISI. In optical communications channels, however, one cannot directly use the general concept of the ML-based JCE. Due to the presence of square-law detection in the receiver for an optical communications system, the output electrical current consists of three parts: signal-signal beat, signal-noise beat, and noise-noise beat. A whitening filter in the electrical domain has not been found such that the filtered output noise after sampling is independent and identically distributed for a signal-dependent noise. In the IMAP-TPC system 100 of the present invention, the conditional electrical pdfs and MAP detector 200 are integrated within the decoding process. Since conditional electrical pdfs take into account both noise and ISI, the soft decoding performed by the TPC decoder 210 and MAP equalization performed by the MAP detector 200 are jointly optimized to reduce the BER.

The operation of the IMAP-TPC decoder 120 begins with the calculation of a reliability measure for each received symbol. For a Gaussian symmetric channel without ISI and the transmitted bits eᵢε{−1, +1}, the reliability measure of the received symbol yi is defined as

$$l ( {y}_{i} \vert {e}_{i} ) = log [ \frac{f ( {y}_{i} \vert {e}_{i} = + 1 )}{f ( {y}_{i} \vert {e}_{i} = - 1 )} ] = \frac{2}{{σ}^{2}} {y}_{i} , \qquad ( 4 )$$

where f(yᵢ|eᵢ) is the Gaussian distributed conditional electrical pdf and, by using equation (4), the Gaussian channel's reliability measure can be established by using the amplitude of the received signal. To find a reliability measure for the dispersive optical communications channel, however, we can not use equation (4) for the reliability measure. To find a reliability measure for the optical fiber channel, several points need to be emphasized. If a communications channel is memoryless, then the noise process affecting a given bit in the received word is independent of the noise affecting the other received bits. In an optical communications system, due to PMD and chromatic dispersion, the optical communications channel cannot be assumed to be memoryless. Moreover, due to the complicated interactions of square-law detection and the optical and the electrical filter effects in the receiver, the noise distribution is no longer Gaussian, but is rather a generalized chi-square distribution. These two fundamental changes require that the TPC decoding algorithm, especially the calculation of the reliability measure for each received symbol, is modified accordingly.

Let the BCH codeword C(n,k) be the constituent codeword of TPC, where n and k stand for the codeword length and the number of information bits, respectively. The transmitted and received BCH codeword can be defined as x=(x₁, x₂, . . . , xₙ) and y=(y₁, y₂, . . . , yₙ), respectively. The reliability of a received symbol is calculated by finding the LLR value computed by the symbol-by-symbol MAP detector 200 as

$${l}_{i} = log \frac{F ( y \text{\vert} {x}_{i} = 1 )}{F ( y \text{\vert} {x}_{i} = 0 )} \\ i = 1 , 2 , ⋯ , n , \qquad ( 5 )$$

where F(y|xᵢ) is defined by (2), and hence combines equalization with the decoding process. Because the value lᵢ is the output LLR of the MAP detector 200, it contains information both noise and ISI information, and hence provides an accurate reliability measure for use in the TPC soft decoding performed by the TPC decoder 210

For a practical IMAP-TPC system 100, the MAP detector 200 is preferably integrated with two systematic linear block codes C1 and C2, with parameters (n₁, k₁, d₁) and (n₂, k₂, d₂), respectively. Here, nᵢ, ki, and dᵢ (i=1, 2) stand for codeword length, number of information bits, and minimum Hamming distance, respectively. The product code P=C1×C2 is obtained by

(1) putting k₁×k₂ information bits in a matrix with k₁ rows and k₂ columns;

(2) coding the k₁ rows using code C1; and

(3) coding the n₂ columns using code C₂.

The resultant product code P(n′, k′, d′) is shown in FIG. 4, which is a block diagram of BCH(n₁,k₁)×BCH(n₂,k₂) product code. The product code has parameters: n′=n₁*n₂, k′=k₁*k₂, and d′=d₁*d₂. If t₁=[(d₁−1)/2] and t₂=[(d₂−1)/2] are the maximum random error correcting capability of the component codes C1 and C2 respectively, the maximum random error correcting capability t′ of the product code P is
t′=└(d−1)/2┘=2t₁t₂+t₁+t₂ (6)

Because the decoding involves a two-step (rows after columns or vice-versa) procedure, sometimes, it is incapable of correcting all the error patterns with t′ or fewer errors in the code matrix P if these errors are beyond the BCH decoder's error correction capability. However, such a decoding process is rather simple and efficient, and thus practical. As will be shown below, it is quite effective as well. In the simulations, we chose n₁=n₂=255 and k₁=k₂=239 so that the TPC has minimum distance of 25 and only 13.83% overhead, and hence is suitable for optical fiber transmissions at 10 Gbits/s or above.

The reliability measure of a received symbol is given by equation (5). However, to calculate the LLR of a received symbol in a BCH codeword C with codeword length n and information bit length k, one must take into account the fact that the ML codeword ĉ is one of the 2ₖ codewords of C. By defining F(y|x)≡F(yi|xi), where x=(x₁, x₂, . . . , xₙ), y=(y₁, y₂, y₃, . . . , yₙ, yₙ₊₁, . . . , yₙ₊₂ₗ₋₂), yi=(yᵢ, yᵢ₊₁, yᵢ₊₂, . . . , yᵢ₊₂ₗ₋₂), and 2l+1 as the optical channel memory length, we can write the LLR of a bit for different codewords C(n, k) as

$$l ( {x}_{i} ) = log \frac{{\sum }_{{x}^{j} ∈ {S}_{i}^{1}} F ( y \text{\vert} x = {x}^{j} )}{{\sum }_{{x}^{j} ∈ {S}_{i}^{0}} F ( y \text{\vert} x = {x}^{j} )} . \qquad ( 7 )$$

where Sᵢ¹ is the set containing the index of codewords xⁱ, j=1, 2, . . . , 2^{k} such that xᵢ^{j}=1, i=1, 2, . . . , n, and Sᵢ⁰ is the set containing the index of codewords x^{j}, j=1, 2, . . . , 2^{k} such that xᵢ^{j}=0, i=1, 2, . . . , n.

Let C¹εSᵢ¹ and C⁰εSᵢ⁰ be the two most probable codewords where C¹=(c₁¹, c₂¹, . . . , cₙ¹) and C⁰=(c₁⁰, c₂⁰, . . . , cₙ⁰), and equation (7) can be rewritten as

$$\begin{matrix}l ( {x}_{i} ) = log \frac{F ( y \text{\vert} {C}^{1} )}{F ( y \text{\vert} {C}^{0} )} + log [ \frac{F ( y \text{\vert} {C}^{0} )}{F ( y \text{\vert} {C}^{1} )} \times \frac{{\sum }_{{x}^{j} ∈ {S}_{i}^{1}} F ( y \text{\vert} x = {x}^{j} )}{{\sum }_{{x}^{j} ∈ {S}_{i}^{0}} F ( y \text{\vert} x = {x}^{j} )} ] \\ = log \frac{F ( y \text{\vert} {C}^{1} )}{F ( y \text{\vert} {C}^{0} )} + log [ \frac{1 + {\sum }_{{x}^{j} ∈ {S}_{i}^{1} , {x}^{j} \neq {C}^{1}} F ( y \text{\vert} {C}^{0} ) F ( y \text{\vert} x = {x}^{j} )}{1 + {\sum }_{{x}^{j} ∈ {S}_{i}^{0} , {x}^{j} \neq {C}^{0}} F ( y \text{\vert} {C}^{1} ) F ( y \text{\vert} x = {x}^{j} )} ] .\end{matrix} \qquad ( 8 )$$

When the optical communications channels operate with a high OSNR, the second term of equation (8) is approximately 0, i.e., Σₓ_{^{j}}_{εs}_{ᵢ}_{¹}_{,x}_{^{j}}_{≠c}_{¹}F(y|C⁰)F(y|x=x^{j})≈0 and Σₓ_{^{j}}_{εs}_{ᵢ}_{⁰}_{,x}_{^{j}}_{≠c}_{⁰}F(y|C¹)F(y|x=x^{j})≈0. By neglecting the second term in equation (8), an approximation for the LLR of decision xᵢ is obtained such that

$$\hat{l} ( {x}_{i} ) = log \frac{F ( y \text{\vert} {C}^{1} )}{F ( y \text{\vert} {C}^{0} )} . \qquad ( 9 )$$

By expanding equation (9), the following relation is obtained:
where

$$\begin{matrix}\hat{l} ( {x}_{i} ) = {l}_{i} + {\sum }_{j = 1 , j \neq i}^{n} {l}_{j} {c}_{j}^{1} {p}_{j} \\ where & ( 10 ) \\ {p}_{j} = \{ \begin{matrix}0 & if {c}_{j}^{1} = {c}_{j}^{0} \\ 1 & if {c}_{j}^{1} \neq {c}_{j}^{0}\end{matrix} . & ( 11 )\end{matrix}$$

Defining wᵢ=Σ_{j=1,j≠i}ⁿlⱼcⱼ¹pⱼ, equation (10) can be rewritten as
\hat{l}(xᵢ)=lᵢ+wᵢ (12)

The way that this quantity is used in the TPC decoder will be explained in more detail below.

Turbo Decoding of Product Code

FIG. 5 is a block diagram of the mth stage of the TPC decoder 210, in accordance with one embodiment of the present invention. The ith channel LLR value lᵢ is input to a delay line 300 and added to the extrinsic information at the mth stage wᵢ^{(m)} to generate soft input l′ᵢ=lᵢ+a^{(m)}wᵢ^{(m)}, where a^{(m)} is the mth stage scaling factor introduced to reduce the effect of extrinsic information when the BER is relatively high.

The LLR value l′ᵢ is the input to a SISO Chase-type II decoder 310. The Chase algorithm is a suboptimum procedure that uses a set of most likely error patterns. These error patterns are selected based on the reliability measure of the received symbols. Each pattern is added to the hard-decision received word, and decoded using a hard-decision decoder. Each decoded codeword is scored by computing its joint probability with respect to the received (soft-decision) sequence. The codeword with the best joint probability is selected as the most likely.

The TPC decoder 210 generates candidate constituent BCH codewords {Dⱼ} using soft input l′ᵢ and computes the LLR of transmitted symbol xᵢ within the set of BCH codewords such that

$${l}_{i}^{″} = log \frac{{\sum }_{{D}_{j}^{1}} F ( y \text{\vert} {x}_{i} )}{{\sum }_{{D}_{j}^{0}} F ( y \text{\vert} {x}_{i} )} \qquad ( 13 )$$

where Dⱼ¹ is the candidate codewords such that the ith bit is one and Dⱼ⁰ are the candidate codewords such that the ith bit is zero, and equation (9) can be used here to approximate equation (13). By subtracting l′ᵢ from the soft input l′ᵢ, we obtain output extrinsic information wₖ^{(m+1})=l′ᵢ−l′ᵢ for the next decoding stage. If only one codeword is found, we can define a reliability measure b^{(m)} and calculate l′ᵢ=b^{(m)}sⱼ|l′ᵢ|, where b^{(m)} is a positive number, and sⱼε{−1, +1} is the sign of the ith output LLR from the BCH decoder.
Application of IMAP-TPC System to PMD Mitigation

FIG. 6 is a block diagram of an optical communications system 500 utilizing the IMAP-TPC system 100, in accordance with one preferred embodiment of the present invention. The system 500 preferably includes a modulator/TPC encoder 510, optical fiber 520, optical amplifiers 530, a receiver 570, a switch 580, a clock recovery circuit 595, an ADC 590, and IMAP-TPC system 100, which preferably includes conditional electrical pdf estimator 110 and IMAP-TPC decoder 120. The receiver 540 preferably includes an optical filter 550, photodetector 560 and electrical filter 570.

The optical communications system 500 shown in FIG. 6 has been used to simulate the performance of the IMAP-TPC system 100 has been demonstrated with respect to PMD mitigation. Bit sequences are transmitted through a dispersive optical channel with all-order PMD and ASE noise. An assumption is made that the optical channel's memory length, i.e., the ISI, induced by all-order PMD is 3, which means the conditional electrical pdfs are conditioned on a three-bit sequence, i.e., f_{y}(yₙ|xₙ₋₁, xₙ, xₙ₊₁).

The numerical simulations were for a 10 Gb/s return-to-zero (RZ) transmission system using Gaussian pulses with full width at half maximum (FWHM) of 50 ps, pulse rise time of 30 ps, and a peak power of 1 mW. To include the effects of ISI due to all-order PMD over a 1000 km fiber, the coarse-step method was used with 80 fiber sections 520 for each 100 km of optical signal transmission. No relationship was imposed between the principal states of the fiber and the input polarization state of the light. ASE noise is added in the optical domain.

After the fiber propagation and optical amplification with optical amplifiers 530, the distorted optical signal, in two polarization states, is filtered by optical filter 550, preferably a Gaussian optical filter with a FWHM bandwidth of 80 GHz, and passes through the photodetector 560 and electrical filter 570, preferably a 5th order electrical Bessel filter with a 3 dB bandwidth of 8 GHz. The electrical current is then sampled by switch 580 and quantized by ADC 590 after the clock recovery with clock recovery circuit 595. The conditional electrical pdfs generated by conditional electrical pdf estimator 110 (such as the conditional electrical pdfs shown in FIG. 3) are preferably stored in lookup table 600 for use by the IMAP-TPC decoder 120. The key parameters used in our simulations are shown in Table (1) below.

TABLE 1
Key parameters of the IMAP-TPC simulations

| parameter name | simulation values |
|---|---|
| data string length | 65536 |
| extinction ratio | −20 dB |
| quantization bit | 10 |
| lookup table resolution | 1024 |
| pdf estimation resolution | 1024 |

BCH(255,239)×BCH(255,239) product code is implemented with error correction capability t=2 for each constituent BCH code. An interleaver 220, preferably a rectangular interleaver with interleaver depth 255, is used between the row and column BCH encoder to generate the TPC code. Since the probability of PMD-induced ISI beyond the immediate neighboring bits due to a center bit in a sequence is very small, the memory length of the optical fiber can be assumed to be three. Based on this assumption, a 3-symbol MAP detector 200 is implemented to calculate the LLR of each symbol, to be integrated into the TPC decoder 210, preferably a SISO TPC decoder. The TPC decoder 210 preferably utilizes a Chase-type II SISO decoder algorithm.

Instead of searching all possible codewords, as is the case for ML decoding, a Chase-type II algorithm only searches 2^{t}−1=3 codewords. Error patterns are generated based on the unreliable positions of a received word using the LLR from MAP detector 200, and then added to the received word to be decoded for BCH codewords. A Berlekamp-Massey algorithm is preferably implemented for the BCH hard decoder in the Chase-type II algorithm. Finally, the output LLR is calculated using equation (13) above, and extrinsic information is output for the next stage row/column decoding.

Although the IMAP-TPC decoder 120 can be used for iterative decoding, it is not practical in optical channels at data rates of 10 Gbits/s and above. Any iteration (feedback soft information to the input of IMAP-TPC decoder 120) is extremely expensive and practically impossible. For practicality, only one iteration was used in the simulations.

To evaluate the degree to which the IAP-TPC system 100 compensates for the all-order PMD distortion and ASE noise in the optical fiber 520, the BERs are compared for the following cases: Adaptive thresholding; MAP detector, and accurate conditional pdfs integrated with TPC. The TPC scheme uses conditional pdfs estimated, and hence it is analogous to the TPC decoding process in a binary unsymmetric channel with Gaussian distribution, but is more accurate in the pdf characterization it uses. We compare these four structures for different differential group delays (DGDs) and optical signal-to-noise ratios (OSNRs).

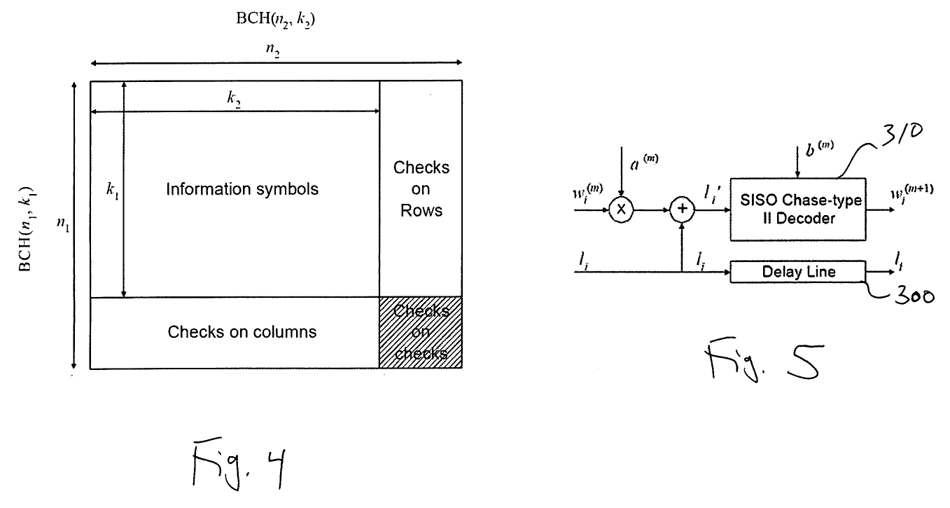

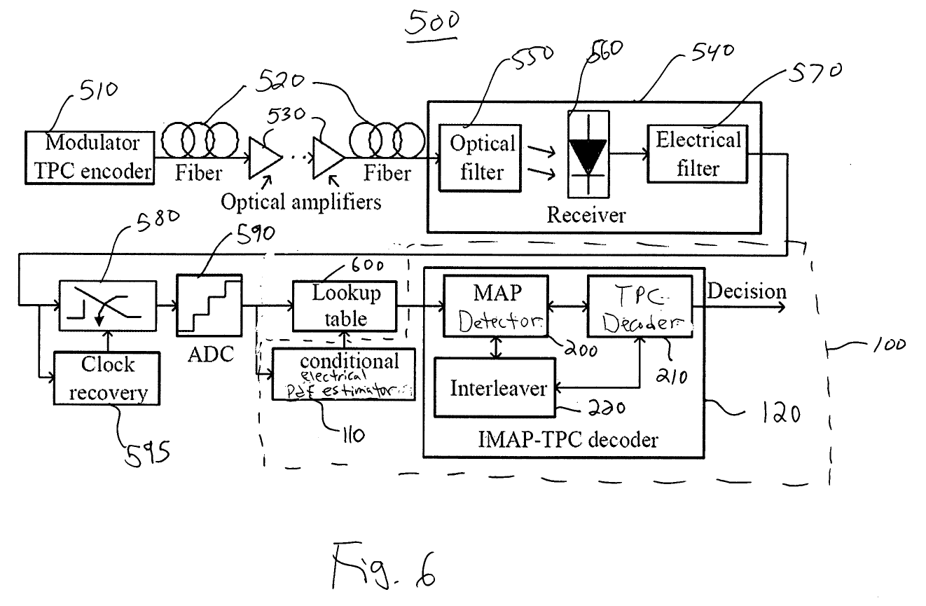

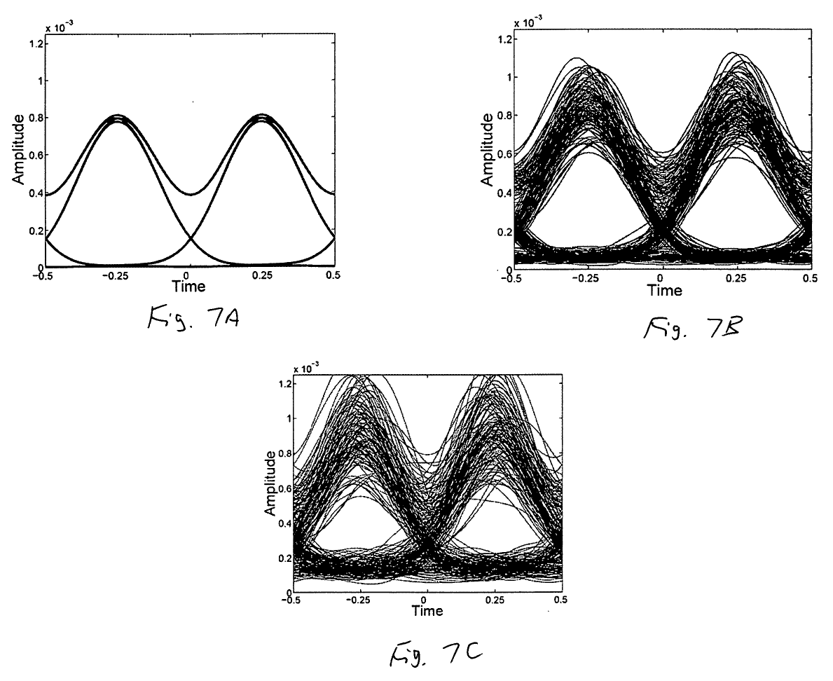

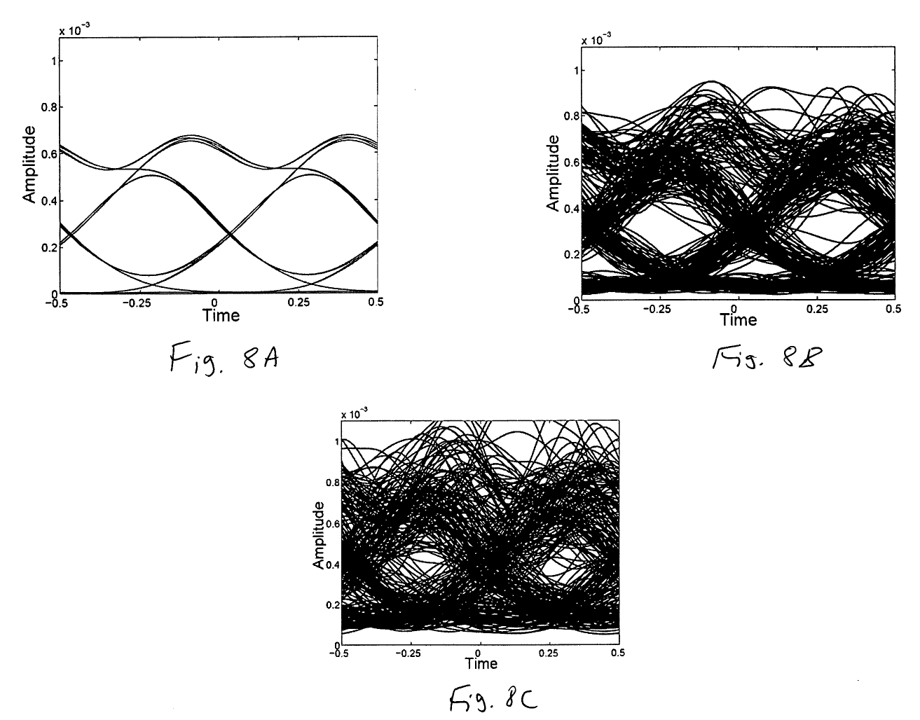

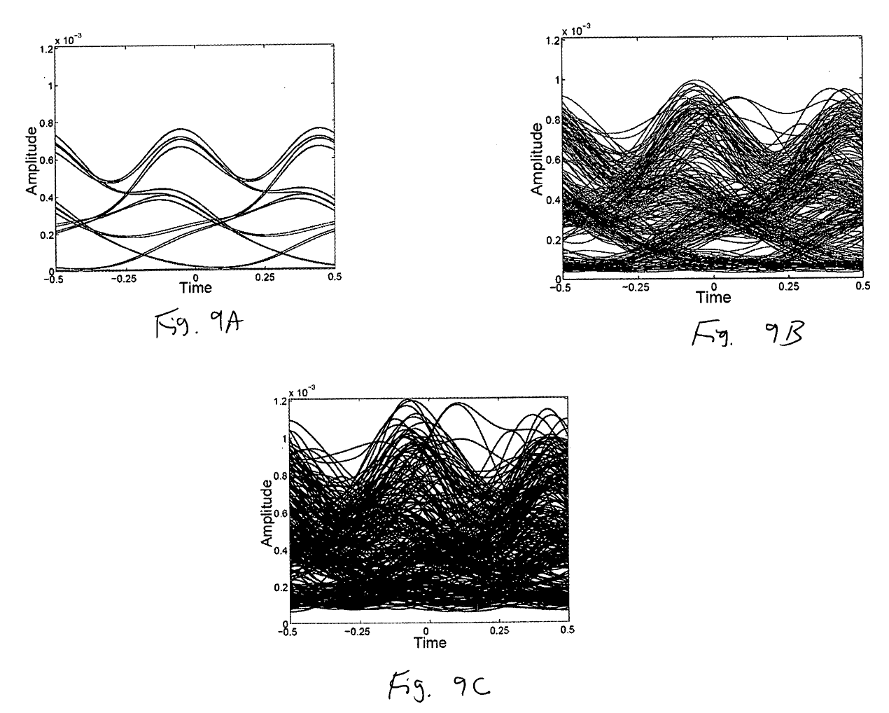

To illustrate the distortions induced by different DGDs and degraded OSNRs, the eye diagrams are given in FIGS. 7-9. FIGS. 7A-7C compares the eye diagrams of a PMD-free signal (DGD=0), with degraded eye patterns due to reduced OSNR. FIGS. 8A-8C and FIGS. 9A-9C show the eye diagrams for DGD=57 ps and DGD=80 ps, respectively, with different OSNRs.

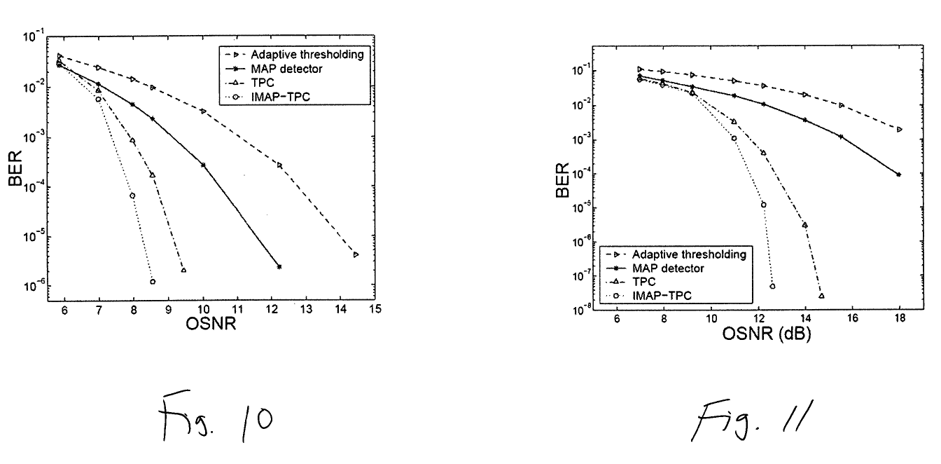

The results shown in FIGS. 10 and 11 are for a fixed fiber realization with a DGD of 57 ps, and 80 ps, respectively. DGDs are chosen near the mean DGDs of fiber realizations. Although the BER levels at 1e-1-1e-2 are not practical, we included them here to show the BER trend.

As shown in FIGS. 10 and 11, the IMAP-TPC system 100 provides significant improvement over other methods as OSNR increases. In FIG. 10, when OSNR is 8.5 dB, the eye diagram in FIG. 8C shows an almost closed eye. However, the IMAP-TPC system 100 provides almost two orders of magnitude gain with respect to TPC, and more than three orders of magnitude gain for both the MAP detector and adaptive thresholding methods.

In FIG. 11, where DGD is large and the eye diagram shows a complete closed eye (in FIGS. 9B and 9C), the IMAP-TPC system still provides more than an order of magnitude gain with respect to TPC at OSNR 12 dB. In the large DGD case, the ISI produced by PMD will gradually spread beyond the immediate neighboring bits, and hence violate the assumption that the ISI due to the center bit of a 3-symbol sequence is well preserved in its neighboring bits. This is the main reason that BER saturation is observed for the MAP detector case in FIG. 11. In this case, the conditional pdf needs to be estimated with larger memory length, e.g., using a five or seven symbol sequence, and a MAP observation length increased accordingly. When there is no DGD, one has to note that the IMAP-TPC system performs just like the TPC. In this case, the MAP reliability measure calculated for the TPC decoding (IMAP-TPC) performs like a normal TPC decoder, because there is no inter-symbol interference and the input conditional pdfs for the MAP can only be conditioned on a symbol (a mark or a space) instead of a sequence of symbols.

It is also noted that both TPC and IMAP-TPC do not perform very well in the low OSNR value. This is due to the large number of uncorrectable words during BCH decoding in a Chase-type II decoder. As OSNR increases, especially to the point that word errors are within the error correction capability of the BCH decoder, the system's overall BER reduces drastically with the IMAP-TPC system.

The IMAP-TPC system 100 of the present invention is both compact and practical in terms of its implementation for OFCS, and can easily be integrated into a large scale integrated circuit chip to enhance the system performance, making it promising for use in short/long-haul OFCS.

The foregoing embodiments and advantages are merely exemplary, and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. Various changes may be made without departing from the spirit and scope of the invention, as defined in the following claims.

What is claimed is:

1. A system for improving the performance of a fiber optic communications system, comprising:
a photodetector for converting a modulated and coded optical signal that has been transmitted through an optical fiber into an electrical signal;
a conditional electrical probability density function (pdf) estimator for estimating a conditional pdf of the electrical signal; and
an integrated maximum a posteriori equalization and turbo product coding (IMAP-TPC) system for receiving the conditional pdf of the electrical signal and for using the conditional pdf to: (1) decode the electrical signal into candidate codewords; and (2) determine which of the candidate codewords are most likely correct.

2. The system of claim 1, wherein the IMAP-TPC comprises:
a maximum a posteriori (MAP) detector for receiving the conditional pdf of the electrical signal and generating a log-likelihood ratio (LLR) based on the conditional pdf; and
a turbo product code (TPC) decoder for receiving the LLR and decoding the electrical signal using the LLR.

3. The system of claim 2, wherein the TPC decoder comprises a soft input soft output (SISO) iterative Chase-type II decoder.

4. The system of claim 1, wherein the modulated and coded optical signal exhibits noise and inter-symbol interference (ISI) effects.

5. A system for improving the bit error rate (BER) of a modulated and coded optical signal that has been transmitted through an optical fiber, comprising:
a conditional electrical probability density function (pdf) estimator for receiving an electrical signal that is representative of the modulated and coded optical signal and for estimating a conditional pdf of the electrical signal; and
an integrated maximum a posteriori equalization and turbo product coding (IMAP-TPC) system for receiving the conditional pdf electrical signal and for using the conditional pdf to: (1) decode the electrical signal into candidate codewords; and (2) determine which of the candidate codewords are most likely correct.

6. The system of claim 5, wherein the IMAP-TPC comprises:
a maximum a posteriori (MAP) detector for receiving the conditional pdf lectrical signal and generating a log-likelihood ratio (LLR) based on the conditional pdf; and
a turbo product code (TPC) decoder for receiving the LLR and decoding the electrical signal using the LLR.

7. The system of claim 6, wherein the TPC decoder comprises a soft input soft output (SISO) iterative Chase-type II decoder.

8. The system of claim 5, wherein the modulated and coded optical signal exhibits noise and inter-symbol interference (ISI) effects.

9. An optical communications system, comprising:
a modulator for modulating and coding an optical signal;
an optical fiber transmission system for transmitting the modulated and coded optical signal;
a receiver for receiving and converting the transmitted optical signal into an electrical signal;
a conditional electrical probability density function (pdf) estimator for receiving electrical signal and estimating a conditional pdf of the electrical signal; and
an integrated maximum a posteriori equalization and turbo product coding (IMAP-TPC) system for receiving the conditional pdf electrical signal and for using the conditional pdf to: (1) decode the electrical signal into candidate codewords; and (2) determine which of the candidate codewords are most likely correct.

10. The system of claim 9, wherein the IMAP-TPC comprises:
a maximum a posteriori (MAP) detector for receiving the conditional pdf of the electrical signal and generating a log-likelihood ratio (LLR) based on the conditional pdf; and
a turbo product code (TPC) decoder for receiving the LLR and decoding the electrical signal using the LLR.

11. The system of claim 10, wherein the TPC decoder comprises a soft input soft output (SISO) iterative Chase-type II decoder.

12. The system of claim 9, wherein the modulated and coded optical signal exhibits noise and inter-symbol interference (ISI) effects.

13. The system of claim 9, wherein the optical fiber transmission system comprises:
an optical fiber; and
at least one optical amplifier.

14. The system of claim 9, wherein the receiver comprises:
an optical filter for optically filtering the transmitted optical signal;
a photodetector for converting the transmitted and filtered optical signal into the electrical signal; and
an electrical filter for electrically filtering the electrical signal.

15. The system of claim 14, wherein the optical filter comprises a Gaussian optical filter.

16. The system of claim 14, wherein the electrical filter comprises a Bessel filter.

17. The system of claim 16, wherein the Bessel filter comprises a 5^{th} order Bessel filter.

18. A method of improving the bit error rate (BER) of an optical signal that has been coded using a turbo product code coding scheme and transmitted through an optical fiber, comprising:
converting the coded optical signal to an electrical signal;
generating a conditional electrical probability density function (pdf) of the electrical signal; and
using the conditional pdf to: (1) decode the electrical signal into candidate codewords; and (2) determine which of the candidate codewords are most likely correct.
